(19) United States
(12) Patent Application Publication
(10) Pub. No.: US 2014/0166788 A1
(43) Pub. Date: Jun. 19, 2014

(54) METHOD AND SYSTEM FOR MAGNETIC SEPARATION OF RARE EARTHS

(71) Applicants: Gary Pearse, Ottawa (CA); Jonathan Borduas, Montreal (CA); Thomas Gervais, Montreal (CA); David Menard, Laval (CA); Djamel Seddaoui, Repentigny (CA); Bora Ung, Quebec (CA)

(72) Inventors: Gary Pearse, Ottawa (CA); Jonathan Borduas, Montreal (CA); Thomas Gervais, Montreal (CA); David Menard, Laval (CA); Djamel Seddaoui, Repentigny (CA); Bora Ung, Quebec (CA)

(21) Appl. No.: 13/822,363

(22) PCT Filed: Aug. 15, 2012
(86) PCT No.: PCT/CA12/50552

§ 371 Date: May 17, 2013

(51) Int. Cl. B03C 1/02; B02C 23/20; B02C 23/08

(52) U.S. Cl. CPC B03C 1/02; B02C 23/08; B02C 23/20
USPC 241/20; 209/212; 209/214; 241/24.14; 241/21

(57) ABSTRACT

A system and a method for separating rare earth element compounds from a slurry of mixed rare earth element compounds, comprising flowing the slurry of mixed rare earth element compounds through at least a first channel rigged with at least a first magnet along a length thereof and connected to at least a first output channel at the position of the magnet, and retrieving individual rare earth element compounds and/or groups of rare earth element compounds, separated from the slurry as they are selectively attracted by the magnet and directed in the corresponding output channel according to their respective ratio of magnetic susceptibility (Δχ) to specific density (Δρ).

### FIELD OF THE INVENTION

The present invention relates to separating and refining rare earth element compounds. More specifically, the present invention is concerned with a method and a system for separating individual rare earth compounds.

### BACKGROUND OF THE INVENTION

Rare earth (RE) elements are typically dispersed and not often found in concentrated and economically exploitable forms. The rare earth elements are virtually always found together within any given RE-mineral. The peculiarity of the atomic structure of the group, in which the outer electron shell of each element contains two electrons and increases in atomic number in the group, occurs with additions of electrons in unfilled sub-shells. It is the outer “valence” shell of an atom that gives it most of its chemical properties. It is this factor that accounts for both the occurrence the elements in close association in nature and the difficulty of separating them from each other.

Production of high purity individual rare-earth (RE) compounds from their ores generally requires two stages of processing, including mineral processing and hydrometallurgy.

During mineral processing, the natural RE-bearing minerals disseminated through the ore are first liberated by crushing and grinding. This is followed by separation and concentration of the RE-rich minerals from the waste minerals, referred to as the gangue, employing methods that exploit one or more differences in physical properties between the RE-rich minerals and the gangue, such as, for example, differences in density, differences in magnetic attraction (also referred to as magnetic susceptibility), differences in electrostatic attraction and mineral surface properties that permit separation by froth flotation. The processing scheme is designed by a mineral processing engineer.

Hydrometallurgy is a processing method in which the mineral concentrate resulting from the mineral processing described hereinabove is broken down, using thermal and chemical agents permitting leaching and separation of RE compounds from unwanted elements. This renders the rare-earth elements amenable to concentration as a group into one of several chemical compound types.

The mixed RE compound species (RE hydroxides, RE oxides or others) are then dissolved into solution using one or more reagents. The solution is purified and the RE are separated from each other into high-purity separate RE compounds in a series of complex transformations exploiting the differences in chemical properties among the group, which include, for example, oxidation, reduction, pH adjustments, reactions to produce other compounds, re-solution, solvent extraction, on exchange, re-precipitation and crystallization. The processing circuits and reagent schemes are designed by an industrial chemist.

FIGS. 1 to 4 are schematics of different separation methods as known in the art.

These methods are multi-chemical, complex, and expensive, due to strikingly similar chemical properties among the rare earth elements as described hereinbelow.

The ionic radii of the RE in the stable 3+ oxidation state diminish from lanthanum down to lutetium, the heaviest RE. This results in a gradual decrease in chemical basicity with atomic weight. Cerium, praseodymium and terbium can have the oxidation state 4+ and samarium, europium, thulium and ytterbium can have the oxidation state 2+. The 4+ state is more basic than the corresponding 3+ state and the 2+ state is less basic than the 3+ state. The difference in basicity is the basis for most of the chemical methods for separating RE. The differences between the basicity of adjacent elements are small—hence the complexity of the separation methods.

Solvent extraction is now the standard method for separating most RE. Briefly, a selected organic chemical (such as 10% HDEHP in kerosene; or tri-butyl-phosphate, or tri-n-butyl amine solvent in 3-methyl-2-butanone, etc. . . . ) that has a slight relative solubility preference for a given RE when mixed with an immiscible highly acidic aqueous solution of RE compounds, will dissolve a small amount of the targeted RE compound. This weak solution is recycled through the process many times before an appreciable amount of the targeted RE has been separated. An extreme example is the case of achieving a purified terbium compound with maximum extraction from the aqueous solution; the organic solvent must be recycled often hundreds to thousands of times. Cerium and Europium in the 4+ and 2+ states respectively can be separated from the other RE on the basis of their compounds different solubility's in aqueous solution but this still requires the use of a variety of acids, salts, reductants and oxidants. Examples of these methods of separation are shown in FIGS. 1 to 4.

These costly, multi-step processes account for the high cost of production of separated RE compounds and clearly also high environmental and health risk associated with supply, handling, operations with and disposal of these reagents.

The profitability of rare earth mining firms hinges on their ability to process and separate the metals into pure rare earth oxides.

There is still a need in the art for a method and a system for separating the individual rare earth element compounds from the mixed RE compounds resulting from hydrometallurgical processes.

### SUMMARY OF THE INVENTION

More specifically, in accordance with the present invention, there is provided a system for separating rare earth element compounds from a slurry of mixed rare earth element compounds, comprising at least a first channel rigged with magnets arranged progressively from weakest to strongest along a length thereof; and an output channel at the position of each magnet; wherein the slurry of mixed rare earth element compounds is flowed in the first channel, each magnet selectively diverting compounds from the slurry on the first channel to its corresponding output channel depending on a ratio of magnetic susceptibility (Δχ) to specific density (Δρ) of each compound.

There is further provided a chemical-free method for separating rare earth element compounds from a slurry of mixed rare earth element compounds, comprising flowing the slurry of mixed rare earth element compounds through at least a first channel rigged with at least a first magnet along a length thereof and connected to at least a first output channel at the position of the magnet, and retrieving individual rare earth element compounds and or groups of rare earth element compounds, separated from the slurry as they are selectively attracted by the magnet and directed in the corresponding output channel according to their respective ratio of magnetic susceptibility (Δχ) to specific density (Δρ).

There is further provided a method for separating individual rare earth element compounds from an ore, comprising: a) liberating natural RE-bearing minerals from the ore; b) separating and concentrating RE-rich material minerals from the RE-bearing minerals to yield RE mineral concentrates; c) separating mixed RE compounds from the RE mineral concentrates; d) passing a slurry of the mixed RE compounds in a first channel rigged with magnets arranged progressively from weakest to strongest along a length thereof, the channel being connected, at the position of each magnet, to an output channel, each output channel diverting separated groups of rare earth element compounds or separated rare earth element compounds from the mixed RE compounds slurry; e) in case of separated groups of rare earth element compounds, for at least one of the groups, continuing to either i) passing the group to a second channel rigged with magnets arranged progressively from weakest to strongest along a length thereof, the second channel being connected, at the position of each magnet, to an output channel, or ii) separating the compounds of the group using a magnetic field; and f) repeating step e) until a target separation between the rare earth element compounds.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a diagrammatic view of a method for recovering europium oxide alone, other RE oxides remaining an unseparated group, as known in the art;

FIG. 2 is a diagrammatic view of a method for recovering only yttrium oxide, with an unseparated group of eight RE from lanthanum to erbium remaining to be separated, as known in the art;

FIG. 3 is a diagrammatic view of a method at Phalaborwa, South Africa for separating out the RE oxides from an ore, as known in the art;

FIG. 4 is a diagrammatic view of a Rhone Poulenc method of producing separated RE oxides, as known in the art;

FIG. 5 show a) manganese carbonate and cerium carbonate deflections in a magnetic field and b) terbium carbonate and lanthanum carbonate deflections in a magnetic field;

FIG. 6 shows attraction of cerium carbonate to steel wool in a magnetic field;

FIG. 7 is a schematic representation of a ferromagnetic/paramagnetic separator according to an embodiment of an aspect of the present invention;

FIG. 8 is a schematic diagram illustrating the separation of ferromagnetic, paramagnetic, nonmagnetic and diamagnetic compounds in a magnetic field; and

FIG. 9 is a schematic illustration of a system for separation of mixed rare earths in compound form, according to an embodiment of an aspect of the present invention.

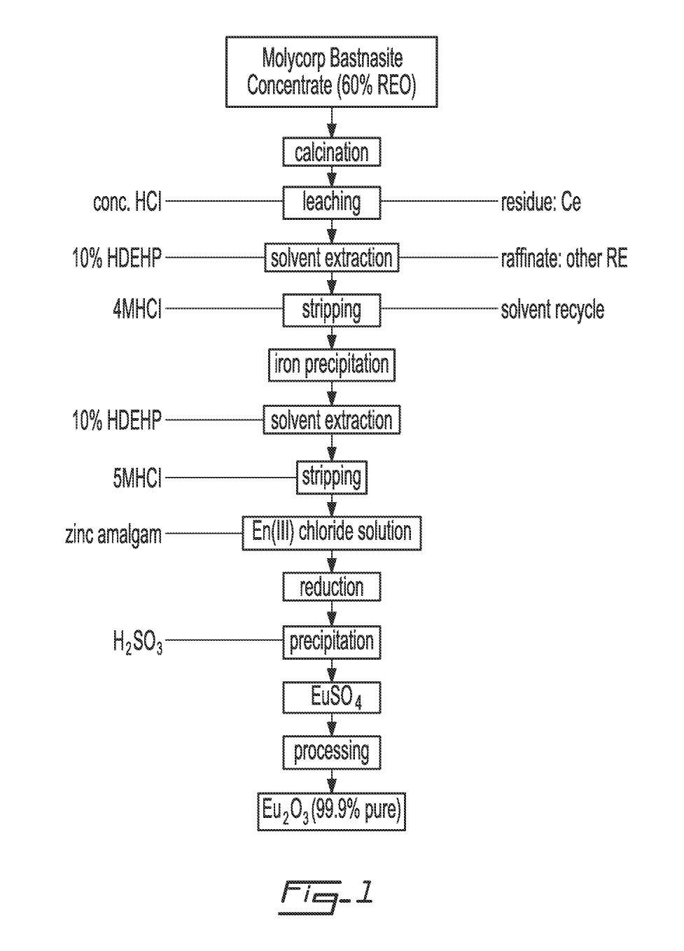

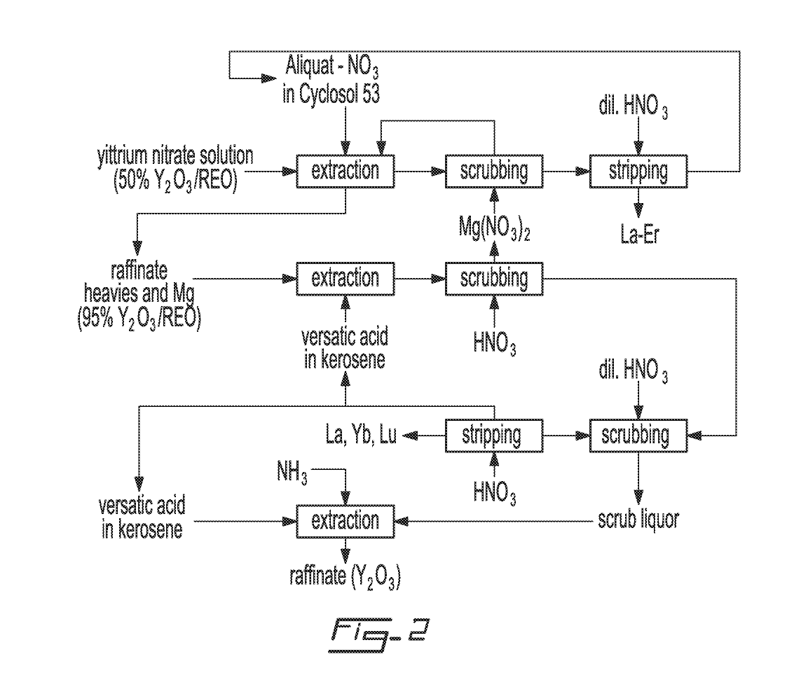

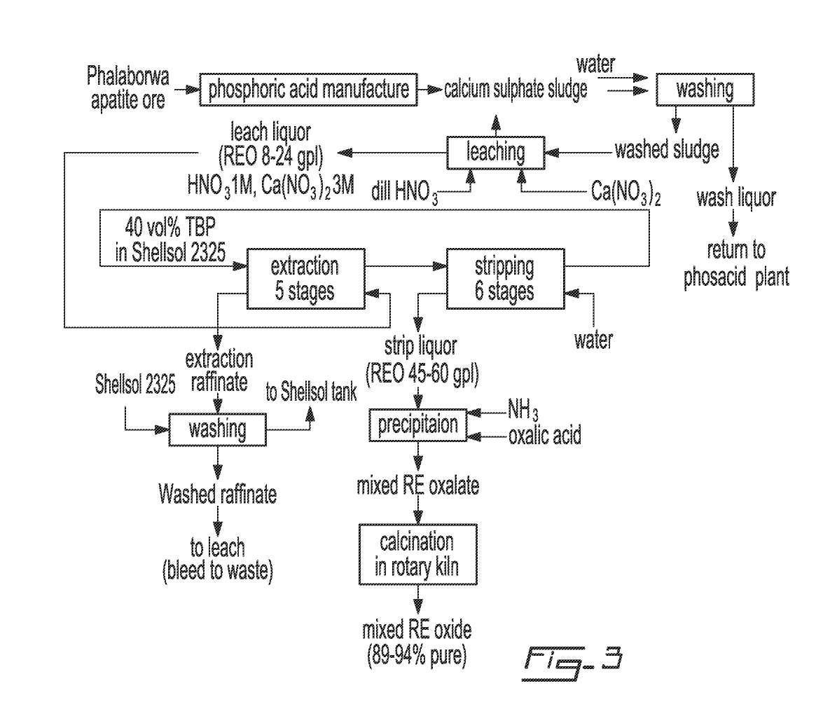

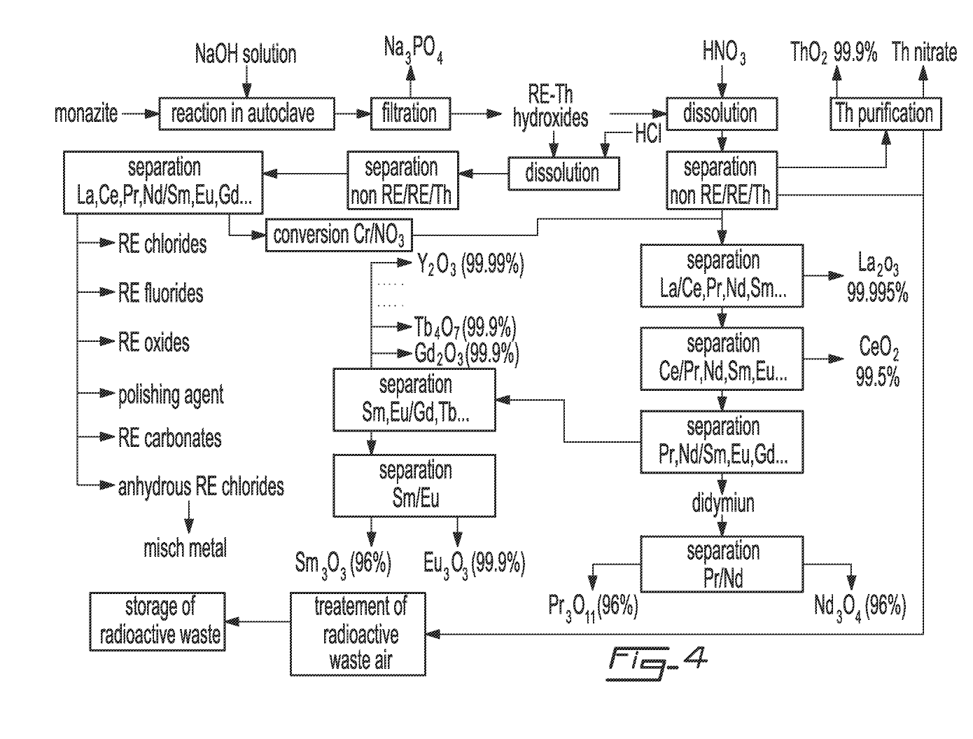

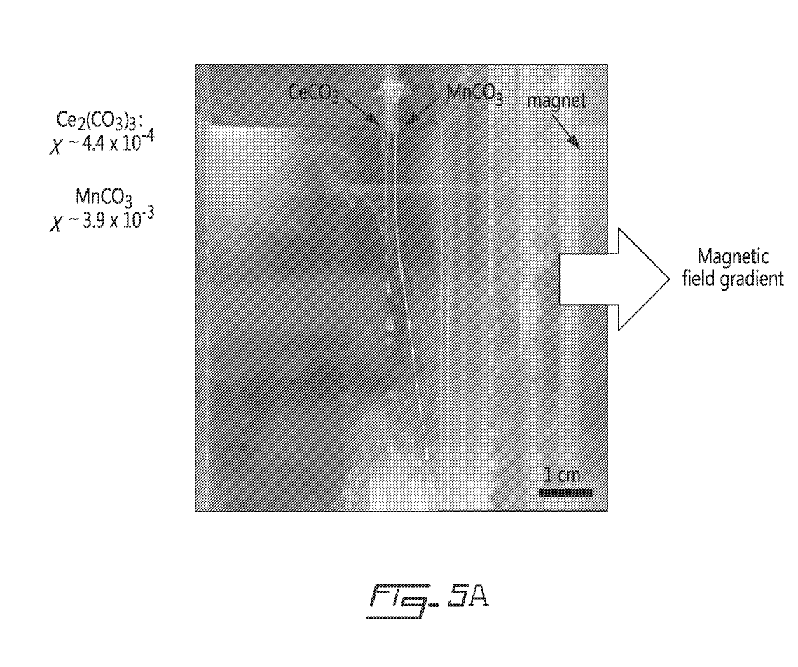

### DESCRIPTION OF EMBODIMENTS OF THE INVENTION

RE-compounds vary widely in their magnetic susceptibilities, from strongly to weakly paramagnetic i.e. attracted to a magnetic field, to diamagnetic i.e. repelled by a magnetic field. For example, Table I below lists the molar magnetic susceptibility (cgs system), in χₘ/10⁻⁶ cm³mol⁻¹ units, of insoluble RE oxides presented in order of RE atomic number, as available in the literature. Other insoluble RE-compounds such as carbonates, fluorides, phosphates, sulphides, etc. could also be characterized by their magnetic susceptibility.

TABLE I

| La3+ | Ce3+ | Pr3+ | Nd3+ | Sm3+ | Eu3+ | Gd3+ | Tb3+ | Dy3+ | Ho3+ | Er3+ | Tm3+ | Yb3+ | Lu3+ | Y3+ |
|---|---|---|---|---|---|---|---|---|---|---|---|---|---|---|
| −78 | ~3,000 | 8,994 | 10,200 | 1,988 | 10,100 | 53,200 | 78,340 | 89,600 | 88,100 | 73,920 | 51,444 | ~−50 | ~10 | 44 |
| | Ce⁴⁺ | | | | Eu²⁺ | | | | | | | | | |
| | 26 | | | | ~25,000 | | | | | | | | | |

Experiments were performed to separate individual RE in compound form one from the other based on differences in magnetic susceptibility, based on the consideration that magnetic separation opposing gravitational and magnetic forces, the magnitude of the separation power for a given element is proportional to the ratio of its magnetic susceptibility Δχ (with respect to the supporting fluid) to its specific density Δρ (with respect to the supporting fluid), i.e. Δχ/Δρ. Therefore, for magnetic separation to be achievable, assuming that appropriate magnetic forces can be produced, the various components must exhibit a sufficient contrast, i.e. difference, in their Δχ/Δρ values. The greater this contrast, the easier the separation will be, and it is assumed that magnetic separation will be easiest when Δχ/Δρ is as high as possible.

Various aqueous and non-aqueous solvents were tested. Their magnetic susceptibility was measured. Since magnetic separation is a process driven by the contrast between the susceptibility of the suspended particles and the susceptibility of the solvent, as mentioned hereinabove, the solvents needs to be selected to achieve efficient separation. The magnetic properties of the solvent can also be tailored as to maximize the separation. Water, as well as virtually all organic solvents, is known to be diamagnetic. However, paramagnetic solvents can be made by dissolving strongly paramagnetic ions, such as Mg²⁺, in an aqueous solution, as known in the art. By varying the concentration of paramagnetic ions, the magnetic properties of the solvent can thus be tailored to optimize separation results.

Experimentations were performed to qualitatively observe magnetic deflection in a free flow sedimentation trial using purified paramagnetic compounds. Manganese carbonate (MnCO₃) was chosen as a first candidate as it has a strong specific paramagnetic susceptibility (χ/ρ=1.2×10⁻⁶ m³/kg) representative of typical susceptibilities of intermediate molecular weight rare earth carbonates. Cerium carbonate (Ce₂(CO₃)₃) was also characterized as a model RE compound (χ/ρ=8.8×10⁻⁸ m³/kg, 14 times less paramagnetic than MnCO₃). Cerium carbonate being mostly hydrophobic with a tendency to agglomerate, commercial soap was added to the solution in order to create a suspension of small Ce₂(CO₃)₃ particles. Two pipettes were used to drop minute amounts of each sample into a glass vial containing a stagnant fluid (water). A strong permanent magnet was placed such as to impose a horizontal magnetic force field perpendicular to the vertical sedimentation path.

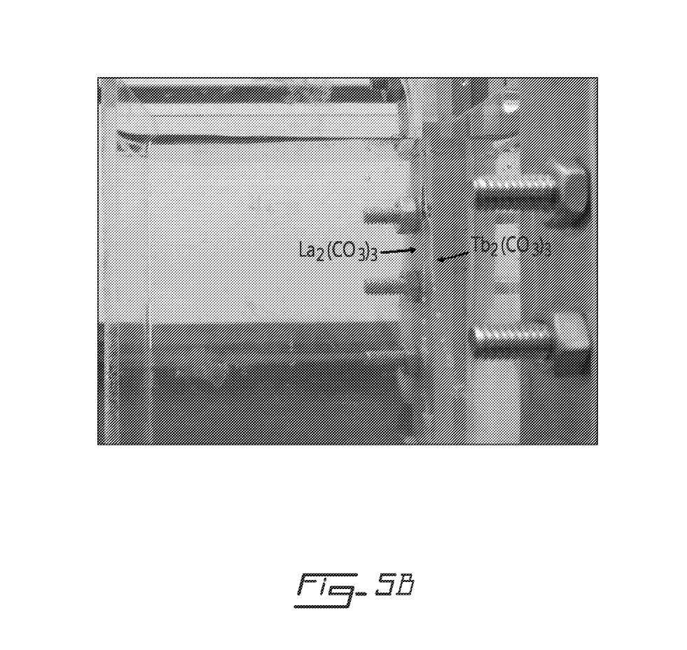

As shown in FIG. 5a, a large deflection of the manganese carbonate was observed, as strongly paramagnetic MnCO₃ is strongly attracted by the magnet. A light deflection of the cerium carbonate was also observed. The deflections were directly proportional to the magnetic force applied and could be made arbitrarily large by increasing the applied field (doubling the field B translates into a 4-fold increase in the magnetic deflection distance). These deflections showed that separating Ce₂(CO₃)₃ is achievable by magnetic means using a sufficiently strong field B, as produced by an electromagnet or a superconducting magnet for example.

Finally, preliminary testing demonstrated that a small fraction of the cerium carbonate sedimenting close to the wall would be sufficiently attracted by the magnet as to stick on the vial's side. This last experiment suggested that separation of cerium carbonate could be optimized by using an extremely thin sedimentation chamber to force the sample to pass as close as possible to the magnet for example. Other ways of confining the fluid close to the magnet may be contemplated.

Deflection and capture of a stream of RE carbonate (trivalent cerium) was thus demonstrated. Since Ce₂(CO₃)₃ has one of the lowest paramagnetic susceptibilities (χ=304×10⁻¹⁰ m³ mol⁻¹) among rare earths compounds, most other RE compounds are expected to display greater deflection and capture in similar experimental conditions.

Similar experiments were done using lanthanum carbonate (La₂(CO₃)₃), which is diamagnetic (χ/ρ=−5.02 E-09) and terbium carbonate (Tb₂(CO₃)₃), which is highly paramagnetic (χ/ρ=+1.86 E-06). As shown in FIG. 5b, Terbium carbonate was strongly deflected toward the magnet, while lanthanum carbonate sedimentated vertically. An experiment using a third RE compound, namely Neodymium Carbonate (Nd₂(CO₃)₃), which is paramagnetic (χ/ρ=+1.93 E-07), similarly resulted in three different sedimentation paths (not shown). The thus separated compounds could then be retrieved in different bins.

Other experiments were done to separate ferromagnetic materials from non-ferromagnetic materials as a first step prior to paramagnetic separation.

A test was performed by sticking a magnet close to a glass vial filled with water in which a mineral RE mixture sample was suspended. It could be observed that when exposed to a strong permanent magnet, almost 100% percent of the samples stuck to the side of the glass vial, indicating a large content of ferromagnetic particles. This was further confirmed by hysteresis loop measurements, which allowed separating the ferromagnetic signal from either a paramagnetic or diamagnetic signal. It also indicated that enrichment is not directly possible when a significant amount of ferromagnetic grains is still present in the sample. Two hypotheses were considered to explain this result. A first hypothesis is that each powder grain contains more than one phase, including one phase that is ferromagnetic. Therefore no separation is possible unless the grains are crushed to smaller dimension until each grain is monophasic. A second hypothesis is that most of the grains are monophasic, yet the ferromagnetic grains get strongly magnetized in the presence of an external magnetic field and produce a strong magnetic gradient resulting in the trapping of all neighboring paramagnetic grains, including those containing the RE.

To discriminate between these two situations, purified cerium carbonate was added to the ore sample. Since cerium carbonate is not ferromagnetic and is not strongly attracted to a magnet next to a glass vial, in the case that each powder grain contains more than one phase, including one phase that is ferromagnetic, the cerium carbonate, under the form of a white powder in the experiment, should precipitate while the ore stuck to the side of the vial. The experimental results showed that the cerium carbonate, despite being weakly paramagnetic, was attracted to the side of the vial by the ferromagnetic material. Such trapping of paramagnetic RE particles by ferromagnetic particles, since it results in the repulsion of diamagnetic particles, can be used for removing the diamagnetic particles from powder samples or for separating the RE from their less paramagnetic environment by choosing the appropriate minimum field to capture the REs.

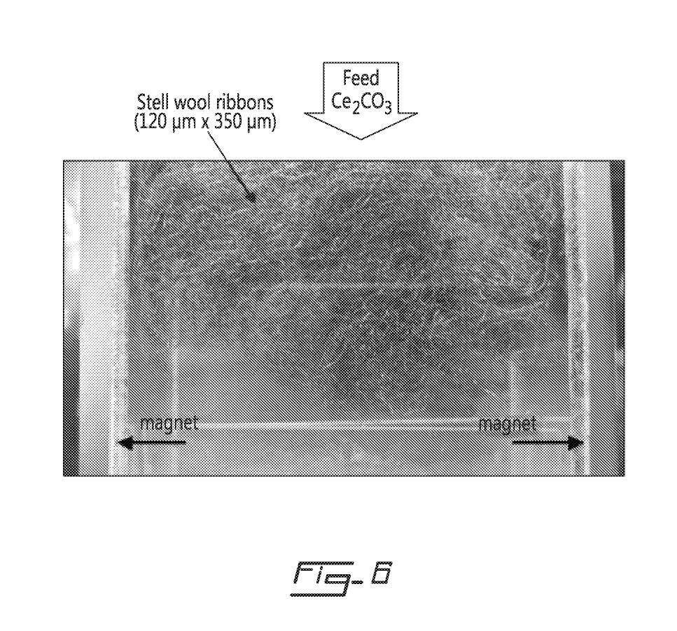

To exploit the observation that paramagnetic particles tend to stick to ferromagnetic materials in the presence of a constant field, a next test was done using a mesh of thin ferromagnetic wires, such as steel wool, to see if they could capture the particles (FIG. 6). A large external field applied to the wire mesh magnetizes it and creates a large magnetic force around it. The thinner the wire, the larger the magnetic force as described in the scaling formula:

$$f \sim \frac{{B}^{2}}{a} ,$$

where f is the force density, B is the magnetic field intensity and a is the wire (or particle) radius.

Since alumina is diamagnetic and should be easily separable from the highly paramagnetic manganese carbonate MnCO₃, a mixture of 50% wt, manganese carbonate and 50% wt. alumina was created. The mixture was suspended in water and mixed thoroughly in a graduated cylinder. Then steel wool was introduced in the cylinder and the cylinder was placed in a large magnetic field (1.4 T) produced by an electromagnet. Then the fluid was flushed in the presence of the field to form the tails. Finally, the cylinder was removed from the magnetic field and the steel wool was flushed with distilled water to form the mags. Both samples were dried out, weighed and their magnetic susceptibility measured using the VSM. Results indicated a strong increase in magnetic susceptibility of the mags with respect to the tails (χ/ρ=19.2×10⁻⁹ m³/kg for the mags vs χ/ρ=2.97×10⁻⁹ m³/kg for the non mags), which showed that the method allows separating a purified paramagnetic sample from a diamagnetic one using relatively low magnetic fields.

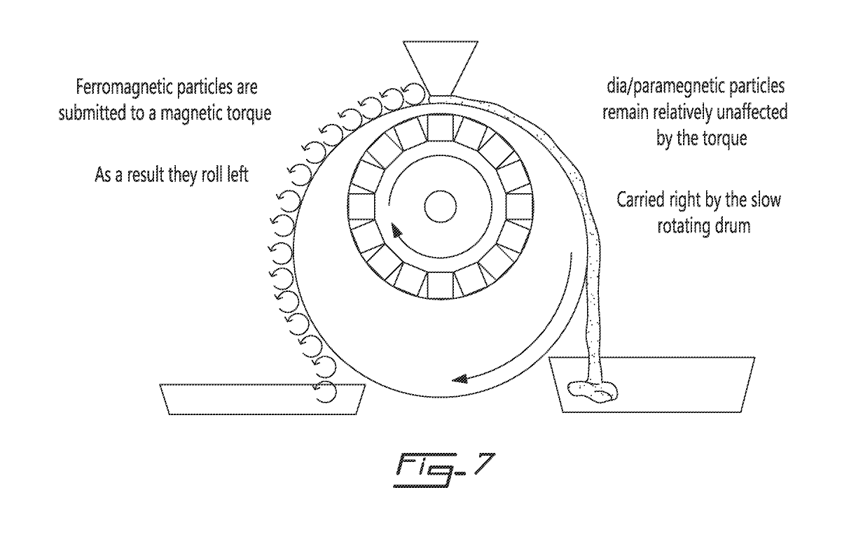

A separator to separate ferromagnetic particles from paramagnetic particles was tested. The separator, as illustrated in FIG. 7, comprised two non-concentric drums, the outer drum rotating slowly clockwise to direct the non mags (tails) into a bin (right handside of FIG. 7) while the inner drum, covered with permanent magnets in an alternating pole configuration, quickly rotates in the opposite direction. The rapid change of polarity in the rotating magnetic drum induces a rotation in the counter clockwise direction and a movement towards the other side of the drums, into a mags bin (on the left handside of FIG. 7). Thus, ferromagnetic separation is achievable using low intensity magnetic fields. Preliminary measurements of the specific magnetic susceptibility in both the mags and non mags bin showed a 5× decrease in the ferromagnetic signal in the non mags after one pass (Mags: 1.26 emu/g, Non mags: 0.26 emu/g). Several passes can be performed successively to achieve greater removal of non-mags. A signal decrease of 12× was ultimately obtained after several passes. Such separator is thus able to filter out residual ferromagnetic grains before moving on to the separation of paramagnetic particles.

From the above, the present separation method and system are based on magnetic properties of the RE for separating the individual rare earth element compounds from mixed RE compounds resulting from hydrometallurgical processes.

RE compounds must first be extracted from the ores and prepared for magnetic separation. Simple chemistry, using an electrolytic cell, can be used to oxidize or reduce certain RE ions in solution to effect further separation using magnetics. Note for example the magnetic susceptibility differences between Eu³⁺ oxide and Eu²⁺ oxide (and similarly for other Eu compounds) and for Ce³⁺ and Ce⁴⁺ compounds. It should be noted here that other insoluble RE-compounds exist, such as hydroxides, carbonates, oxalates, phosphates, fluorides and sulphides and these have magnetic susceptibilities different than the oxides in the table above, although for most types of compounds, the relative differences among them are roughly of similar magnitude (i.e. for example, the central, intermediate atomic weight rare earth fluorides, Tb, Dy, Ho and Er are very highly paramagnetic, with values for the lighter and heavier RE fluorides flanking them diminishing to low values). For example, Sm-sulphide's susceptibility is higher at 3300 compared with Sm-oxide of 1988 (Table I above, the units are cgs units in Table I and not SI units), whereas Nd-sulphide is 5550, almost half of the oxide at 10,200. The application of the susceptibility differences between compounds is explained hereinbelow.

Extraction of the RE elements from an RE-mineral concentrate into solution can be done using mineral acids or caustic soda, with or without roasting. One or two stages of simple chemical techniques are then used to precipitate a mix of RE-compounds that can then be passed through a magnetic separation apparatus.

An example of such a process is as follows. The RE-mineral concentrate is prepared from mined ore from a carbonatite ore deposit, made up principally of carbonate minerals of calcium, magnesium, barium, strontium, iron and RE-fluorocarbonate minerals plus lesser minerals-silicates like quartz, mica and hornblende and oxides like magnetite (iron ore), ilmenite (titanium ore) and pyrochlore (niobium ore).

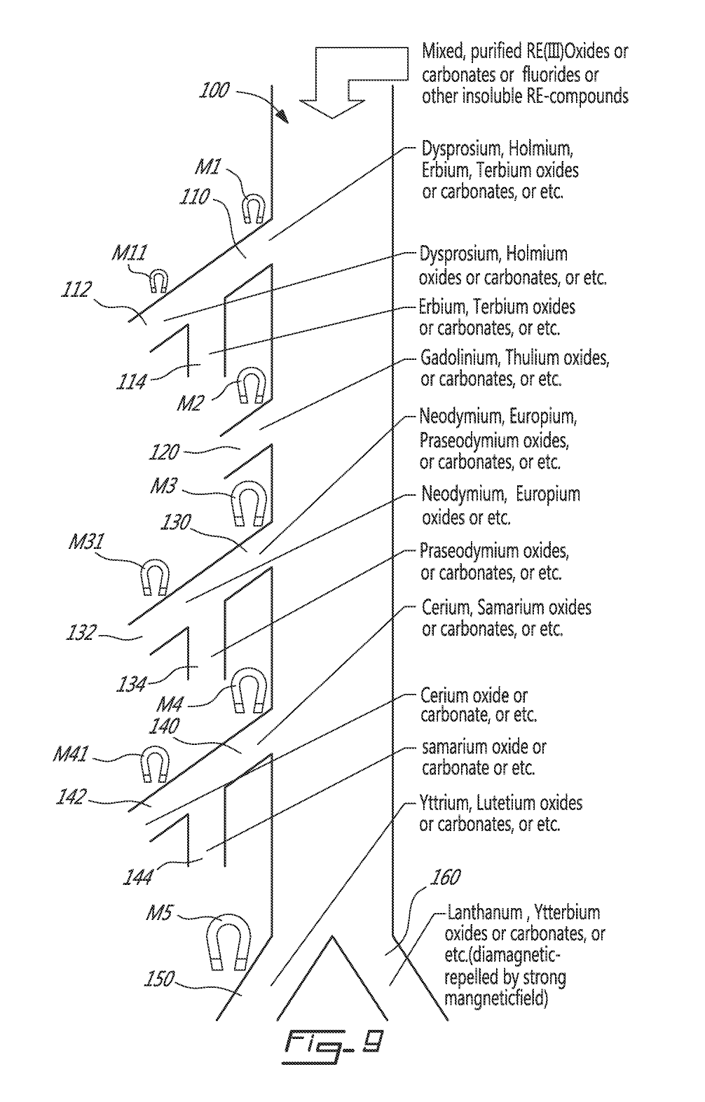

The concentrate is reacted with concentrated hydrochloric acid which dissolves the carbonate gangue minerals (which have been greatly reduced in mineral concentrating process that rejects gangue minerals) and the RE-fluorocarbonates. This puts the RE into solution. The solution is then purified by one of several means to remove the unwanted gangue elements. It may be titrated with sulphuric acid, for example, to precipitate calcium, barium and strontium as sulphates, leaving the RE in solution. The final mixed RE solution can be precipitated as insoluble species—carbonates, phosphates, oxalates, fluorides, etc. and introduced into a separation system as schematically illustrated in FIG. 9 for example.

FIG. 9 is a schematic illustration of a system for separation of mixed rare earths in compound form (e.g. RE-oxides) settling in a water column rigged with magnets arranged progressively from weakest at the top for attracting rare earth of high magnetic susceptibility to strongest in the lower portion for attracting rare earths of the weakest susceptibility. Also, diamagnetic rare earths are repelled away from the magnetic field to bins on the opposite side. Such a separator performs a “rougher” separation into individual and groups of RE-compounds, which can then be further separated as described hereinbelow.

The fluid used in the RE-separator can be water, or water with additives to make it magnetic, as discussed hereinabove in relation to solvents, or denser to affect the settling rate. Different solvents may be used along the way depending of the RE compounds mixture and RE compounds groups separated therefrom. As a result, although FIG. 9 describes a flow-through process using a single unit comprising a RE-separator channel with output channels, several units may be needed.

Ethanol may be used to allow deep cooling of the fluid, which changes magnetic properties of the compounds. For example, Holmium and Dysprosium oxides have close magnetic susceptibilities and would go together in a rougher concentrate. However at 176 Kelvin, dysprosium becomes ferrimagnetic and would behave as non-magnetic, whereas Holmium remains strongly magnetic—a feature that would allow further separation as will be described hereinbelow.

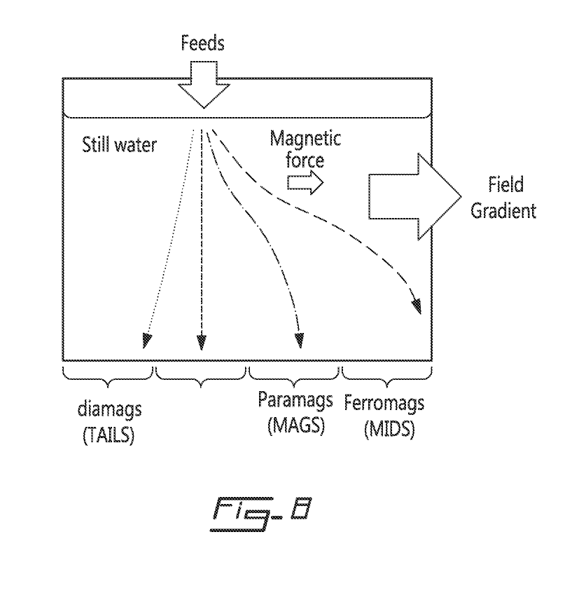

Other oxidation states (for the species in which they occur) of the RE have different magnetic susceptibilities between them. Ce³⁺oxide, for example is moderately susceptible at ˜3000 (see Table I), whereas Ce⁴⁺ is almost non magnetic. Reduction of Eu³⁺oxide to Eu²⁺oxide allows separation of Eu³⁺ oxide from Nd³⁺ oxide which have similar magnetic susceptibilities and report together in a first pass in a system employing various magnetic field strengths (see FIGS. 8 and 9). The oxidation or reduction can be accomplished in an electrolysis cell without using chemicals. Reducing or oxidizing the RE-mixed solution before precipitation and introduction into the RE-compound separator is expected to result in one or more additional separations of individual RE-compounds in the “rougher” first pass as described herein.

Thus, the present system concentrates individual RE-compounds. This requires multiple output bins and a progression of high intensity magnets grading in strength from the weakest at the top of the settling column, in case of a vertical configuration for example, to attract RE-compound species that have the highest susceptibility, progressing to higher strengths down the column to the highest field strength in the lower levels to attract RE-compound grains of the lowest magnetic susceptibility (see FIG. 9). Each magnet has a declining gradient that prevents particles from being caught up on the walls of the bins after they have been separated into their bins. The column and magnets may have many possible shapes and configurations, the objective being to ensure the RE-compounds are not separated far from the magnets. A simple arrangement is to have a column having a flat rectangular cross-section with the magnets rigged across the width of one of the flat walls, inside or outside of the column.

In practice, the RE-compound species may first be concentrated as groups with a similar range of susceptibilities, yielding “rougher” concentrates, and then each group may be further separated in refining stages. The concept of “rougher” concentration is well known in the metallurgical field and is used for all techniques of concentration. FIG. 9 shows the rougher concentrations of groups and individual RE-oxides, etc. These groups are subsequently separated in refining magnetic separation stages.

A number of configurations and operations of this system are possible. In a possible vertical orientation as described hereinabove for example, the system may be column, through which a slurry of the mixed RE compounds is passed; a counter flow of water may be provided to retard settling, particularly of coarser grained particles to allow greater deflection of the settling grains, or a flow substantially along the flow of the slurry may be added to improve productivity by speeding up downward movement of finer grained particles. Such flows should be slow enough to avoid turbulence affecting the deflections of the particles, in an horizontal configuration for example, the system may be a tubular channel with horizontally flowing slurry of the mixed RE compounds therethough and magnets above the slurry lifting the paramagnetic particles and allowing diamagnetic particles to settle, a widening of conduit beyond the output bins slowing the flow and allowing settling into the bins. Other orientations, such as inclined channels, are possible.

La and Ce are abundant RE and are therefore of lower value but in volume they represent an income and the cheaper production method herein described would make them more profitable. Lutetium is a very minor RE and has few uses. It is only slightly paramagnetic, though, and it would accumulate with Y in a rougher concentrate. La and Yb are diamagnetic and are repelled by the magnet to form a rougher concentrate of the two.

There is thus provided a cost-effective, environmentally friendly, non-chemical-based method and system for separating and refining rare earth element compounds produced by hydrometallurgical processes, i.e. for separating the RE species from each other after they have been extracted from the RE concentrate into solution.

Thus, there is provided a method for separating rare earths, comprising:
mining RE-mineral ore, crushing and grinding to a size that substantially liberates constituent minerals, thereby yielding RE-minerals and gangue or waste minerals (step 10);
substantially separates RE-minerals from gangue minerals, using a suitable selection of physical metallurgical techniques such as flotation of RE-minerals or gangue minerals or both in series, to form a concentrate of the RE-minerals (step 20);
extracting the RE into solution by attacking the RE-mineral concentrate with a mineral acid, i.e. commonly HCl for example, or caustic (NaOH), with or without prior heating or roasting (step 30);
purifying the solution to remove unwanted dissolved gangue ions such as calcium, magnesium, iron, barium and strontium by precipitation as sulphates, or hydroxides using sulphuric acid or lime titration or both at pH conditions that leave a high proportion of RE ions in solution (step 40);
treating the RE-solution with reagents to precipitate insoluble RE-compounds such as fluorides, carbonates, phosphates, oxalates, hydroxides and sulphides, the precipitate (for example RE-Carbonates) is therefore made up of a mix of individual RE-carbonates: La₂(CO₃)₃, Ce₂(CO₃)₃, Pr₂(CO₃)₃, Nd₂(CO₃)₃, . . . and all the other RE-carbonates. These can be converted to the corresponding oxides by drying and heating (step 50);
separating ferromagnetic materials from non-ferromagnetic materials, as discussed in relation to FIGS. 6 and 7 hereinabove. As mentioned hereinabove, solvent are selected to achieve optimal separation (step 60); and
introducing the RE-compound species (for example RE-carbonates or RE-oxides or etc.) as a slurry of particles into a system as illustrated for example in FIG. 9, which is filled with water or other fluid to allow settling of the particles. As mentioned hereinabove, solvents are selected to achieve optimal separation (step 70).

In a flow-through configuration as schematized in FIG. 9 for example, as the settling particles reach, along the channel 100, the position of a first weak magnetic field M1 sufficient to attract the compounds of RE of the highest magnetic susceptibility range, such as Dysprosium, Holmium, Erbium and Terbium (see Table 1), these compounds are diverted from the incoming slurry of particles in the channel 10 into a same first output channel 120. The field M1 may be selected to attract susceptibilities at Xₘ=65,000×10⁻⁶ cm³mol⁻¹ units for example. The actual strength of the electromagnets depends on the configuration of the apparatus, particularly the spacing between the stream of particles and the magnets. The electromagnets are tunable to the optimum field strength.

Two secondary channels 112 and 114 are shown to split off from channel 110 in FIG. 9. Channel 112 is rigged with a magnet M12 weaker than M1 generating a field sufficient to attract only particles with a magnetic susceptibility greater than 80,000×10−6 cm³mol⁻¹ units for example, which then attracts only compounds of Dysprosium and Holmium from the flow coming from channel 110, while Erbium and Terbium continue into secondary channel 114 by gravity for example.

Along the length of channel 100, a second magnet M2 located downstream of first magnet M2 is located, which has an intermediate strength generating a field sufficient to attract only particles with a magnetic susceptibility greater than 40,000×10⁻⁶ cm³mol⁻¹ units, i.e. only compounds of Gadolinium and Thulium for example, which are then diverted from the main flow in channel 100 to a second output channel 120.

Still along the length of channel 100, a magnet M3 of intermediate-strong strength generates a field sufficient to attract only particles with a magnetic susceptibility greater than 8,000×10⁻⁶ cm³mol⁻¹ units for example, and thus only Neodymium, Europium and Praseodymium are diverted from the main flow in channel 100 into output channel 130. Two secondary channels 132 and 134 split off from channel 130 in FIG. 9. Channel 132 is rigged with a weaker intermediate-strong magnet M31 generating a field sufficient to attract only particles with a magnetic susceptibility greater than 9,500×10⁻⁶ cm³mol−¹ units, which then attract only compounds of Neodymium and Europium into channel 132, while Praseodymium continues into channel 134.

Still along the length of channel 100, a strong electromagnet M4 generates a field sufficient to attract only particles with a magnetic susceptibility greater than 1,500×10⁻⁶ cm³mol⁻¹ units, and thus attracts only compounds of Cerium (3+) and Samarium into output channel 140. Two secondary channels 142 and 144 split off from output channel 140 in FIG. 9. Channel 142 is rigged with a slightly weaker strong magnet M41 generating a field sufficient to attract only particles with a magnetic susceptibility greater than 2,500×10⁻⁶ cm³mol⁻¹ units, which attracts only compounds of Cerium (3+) while Samarium continues from output channel 140 to channel 144.

Still along the length of channel 100, a very strong electromagnet M5 generates a field sufficient to attract only particles with a magnetic susceptibility greater than 5×10⁻⁶ cm³mol−¹ units, which attracts, from the slurry in main channel 100 into output channel 150, only compounds of Yttrium and Lutetium.

An output channel 160 collects only diamagnetic particles which are repelled by the series of magnets, M1 at the top all the way down to the very strong magnetic M5. These particles are of compounds of Lanthanum and Ytterbium for example.

By the word magnet as used herein throughout, it is referred to any device that can produce a certain distribution of magnetic field in a given space, whether it is an arrangement of permanent magnets, a superconducting coil, or any geometric combination of coils and magnetic materials (soft or hard) for example.

Moreover, the term susceptibility as used herein throughout refers to mass susceptibility or susceptibility over density.

As a result, individual pure rare earth compounds Samarium, Cerium, and Praseodymium plus groups of compounds of Dysprosium-Holmium, Erbium-Terbium, Gadolinium-Thulium, Neodymium-Europium, Yttrium-Lutetium and Lanthanum-Ytterbium, i.e. “rougher” concentrations are obtained, collected in separate bins at the different output channels. These pairs can be subject to a refining step to effect separation in case they occur.

For separating Dysprosium-Holmium, a separator filled with ethanol cooled to below 176K and using a mesh of thin ferromagnetic wires as discussed in relation to FIG. 6 above can be used, since at this temperature, Dysprosium is ferrimagnetic, i.e. for practical terms non-magnetic, while Holmium remains strongly paramagnetic,

In the case of the Erbium-Terbium pair, cooling to below 230K renders Terbium ferrimagnetic while Erbium remains magnetic, permitting separation as discussed in relation to FIG. 6 above.

For separating Gadolinium-Thulium, the pair can be dissolved and placed in an electrolytic cell for reduction of only Thulium to 2+ which creates increased magnetic susceptibility of Thulium and separation can be made.

For separating Neodymium-Europium, the pair can be dissolved and placed in an electrolytic cell for reduction of only Europium to 2+ which creates increased magnetic susceptibility of Europium (see Table 1) and separation can be made.

For separating Lanthanum-Ytterbium, the pair can be dissolved and placed in an electrolytic cell for reduction only of Ytterbium to 2+ which creates increased magnetic susceptibility of Ytterbium and separation can be made.

In the case of Yttrium-Lutetium, the fact that compounds of these two RE have a large difference in specific gravity, these elements being the lightest and the heaviest of the group respectively, sedimentation, i.e. differential settling in water can be used for separation (Y atomic weight 88.9 and Lu atomic weight 175).

In practical terms, the heaviest rare earths Er, Tm, Yb and Lu are in relatively minor amounts in most ores and even unseparated from more abundant RE, they often represent only a few parts per million as impurities in other RE products.

Although the present invention has been described hereinabove by way of specific embodiments thereof, it can be modified, without departing from the nature and teachings of the subject invention as defined in the appended claims.

1. A system for separating rare earth element compounds from a slurry of mixed rare earth element compounds, comprising:
at least a first channel rigged with magnets arranged progressively from weakest to strongest along a length thereof; and
an output channel at the position of each magnet;
wherein the slurry of mixed rare earth element compounds is flowed in said first channel, each magnet selectively diverting compounds from the slurry on the first channel to a corresponding output channel depending on a ratio of magnetic susceptibility (Δχ) to specific density (Δρ) of each compound.

2. The system of claim 1, wherein each output channel leads to at least one collecting bin.

3. The system of claim 1, of a vertical configuration, said first channel being a settling column rigged with magnets arranged progressively from weakest at a top of the column for attracting rare earth compounds of high magnetic susceptibility to strongest in a lower part of the column for attracting rare earth compounds of the weakest susceptibility.

4. The system of claim 1, of a vertical configuration, said first channel being a settling column rigged with magnets arranged progressively from weakest at a top of the column for attracting rare earth compounds of high magnetic susceptibility to strongest in a lower part of the column for attracting rare earth compounds of the weakest susceptibility, wherein said settling column has a flat rectangular cross-section with the magnets rigged across the width of a flat wall thereof, inside or outside of the column.

5. The system of claim 1, of a vertical configuration, said first channel being a settling column rigged with magnets arranged progressively from weakest at a top of the column for attracting rare earth compounds of high magnetic susceptibility to strongest in a lower part of the column for attracting rare earth compounds of the weakest susceptibility, wherein said column comprises a slow counter flow opposite a flow of said slurry of mixed rare earth element compounds therewithin.

6. The system of claim 1, of a vertical configuration, said first channel being a settling column rigged with magnets arranged progressively from weakest at a top of the column for attracting rare earth compounds of high magnetic susceptibility to strongest in a lower part of the column for attracting rare earth compounds of the weakest susceptibility, wherein said column comprises a slow flow along a flow of said slurry of mixed rare earth element compounds.

7. The system of any one of claim 1, of one of: i) a horizontal configuration and ii) an inclined configuration.

8. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel.

9. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel, further comprising, downstream of said first magnet, at least a second magnet attracting compounds of susceptibilities of at least 40,000×10⁻⁶ cm³mol⁻¹ units and diverting a second group of compounds from the slurry flowing in the first channel into a second output channel.

10. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel, further comprising, downstream of said first magnet, at least a second magnet attracting compounds of susceptibilities of at least 40,000×10⁻⁶ cm³mol⁻¹ units and diverting a second group of compounds from the slurry flowing in the first channel into a second output channel, and further comprising, downstream of said second magnet, a third magnet attracting compounds of susceptibilities of at least 8,000×10⁻⁶ cm³mol⁻¹ units and diverting a third group of compounds from the slurry flowing in the first channel into a third output channel.

11. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel, further comprising, downstream of said first magnet, at least a second magnet attracting compounds of susceptibilities of at least 40,000×10⁻⁶ cm³mol⁻¹ units and diverting a second group of compounds from the slurry flowing in the first channel into a second output channel, further comprising, downstream of said second magnet, a third magnet attracting compounds of susceptibilities of at least 8,000×10⁻⁶ cm³mol⁻¹ units and diverting a third group of compounds from the slurry flowing in the first channel into a third output channel, and further comprising, downstream of said third magnet, a fourth magnet attracting compounds of susceptibilities of at least 1,500×10⁻⁶ cm³mol⁻¹ units and diverting a fourth group of compounds from the slurry flowing in the first channel into a fourth output channel.

12. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel, further comprising, downstream of said first magnet, at least a second magnet attracting compounds of susceptibilities of at least 40,000×10⁻⁶ cm³mol⁻¹ units and diverting a second group of compounds from the slurry flowing in the first channel into a second output channel, further comprising, downstream of said second magnet, a third magnet attracting compounds of susceptibilities of at least 8,000×10⁻⁶ cm³mol⁻¹ units and diverting a third group of compounds from the slurry flowing in the first channel into a third output channel, further comprising, downstream of said third magnet, a fourth magnet attracting compounds of susceptibilities of at least 1,500×10⁻⁶ cm³mol⁻¹ units and diverting a fourth group of compounds from the slurry flowing in the first channel into a fourth output channel, and further comprising, downstream of said fourth magnet, a fifth magnet attracting compounds of susceptibilities of at least 5×10⁻⁶ cm³mol−¹ units and diverting a fifth group of compounds from the slurry flowing in the first channel into a fifth output channel.

13. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel, wherein said first output channel splits into a first secondary channel and a second secondary channels, said first secondary channel being rigged with a magnet attracting compounds of susceptibilities of at least 80,000×10⁻⁶ cm³mol⁻¹ units and diverting a first part of said first group into said first secondary channel output channel, a remaining part of said first group continuing into said second secondary channel.

14. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel, further comprising, downstream of said first magnet, at least a second magnet attracting compounds of susceptibilities of at least 40,000×10⁻⁶ cm³mol⁻¹ units and diverting a second group of compounds from the slurry flowing in the first channel into a second output channel, and further comprising, downstream of said second magnet, a third magnet attracting compounds of susceptibilities of at least 8,000×10⁻⁶ cm³mol⁻¹ units and diverting a third group of compounds from the slurry flowing in the first channel into a third output channel, wherein said third output channel splits into a third secondary channel and a fourth secondary channels, said third secondary channel being rigged with a magnet attracting compounds of susceptibilities of at least 9,500×10⁻⁶ cm³mol−¹ units and diverting a first part of said third group into said third secondary output channel, a remaining part of said third group continuing into said fourth secondary channel.

15. The system of claim 1, comprising at least a first magnet attracting compounds of susceptibilities of at least 65,000×10⁻⁶ cm³mol⁻¹ units and diverting a first group of compounds from the slurry flowing in the first channel into a first output channel, further comprising, downstream of said first magnet, at least a second magnet attracting compounds of susceptibilities of at least 40,000×10⁻⁶ cm³mol⁻¹ units and diverting a second group of compounds from the slurry flowing in the first channel into a second output channel, further comprising, downstream of said second magnet, a third magnet attracting compounds of susceptibilities of at least 8,000×10⁻⁶ cm³mol⁻¹ units and diverting a third group of compounds from the slurry flowing in the first channel into a third output channel, and further comprising, downstream of said third magnet, a fourth magnet attracting compounds of susceptibilities of at least 1,500×10⁻⁶ cm³mol⁻¹ units and diverting a fourth group of compounds from the slurry flowing in the first channel into a fourth output channel, wherein said fourth output channel splits into a fifth secondary channel and a sixth secondary channel, said fifth secondary channel being rigged with a magnet attracting compounds of susceptibilities of at least 2,500×10⁻⁶ cm³mol⁻¹ units and diverting a first part of said fourth group into said fifth secondary output channel, a remaining part of said fourth group continuing into said sixth secondary channel.

16. A chemical-free method for separating rare earth element compounds from a slurry of mixed rare earth element compounds, comprising a) flowing the slurry of mixed rare earth element compounds through at least a first channel rigged with at least a first magnet along a length thereof and connected to at least a first output channel at the position of the magnet, and retrieving at least one of: i) individual rare earth element compounds and ii) groups of rare earth element compounds, separated from the slurry as they are selectively attracted by the magnet and directed in the corresponding output channel according to their respective ratio of magnetic susceptibility (Δχ) to specific density (Δρ).

17. The method of claim 16, wherein said step a) comprises flowing the slurry of mixed rare earth element compounds through a settling column rigged with magnets arranged progressively from weakest at the top for attracting rare earth compounds or groups of rare earth compounds of high magnetic susceptibility to strongest in the lower portion for attracting rare earth compounds or groups of rare earth compounds of the weakest susceptibility.

18. The method of claim 16, wherein said step a) comprises flowing the slurry of mixed rare earth element compounds through of a horizontal or inclined channel.

19. The method of claim 16, comprising providing a slow counter flow opposite a flow of the slurry of mixed rare earth element compounds in the channel.

20. The method of claim 16, comprising providing a slow flow along a flow of the slurry of the mixed rare earth element compounds in the channel.

21. The method of claim 16, comprising, before said step a), removing ferromagnetic RE compounds elements from the mixed rare earth element compounds using a magnetic field.

22. The method of claim 16, comprising, before said step a), removing diamagnetic RE compounds from the mixed rare earth element compounds using a magnetic field.

23. The method of claim 16, wherein said step a) separates the rare earth element compounds into groups of rare earth element compounds, said method further comprising, for at least one of the separated groups, b) directing the group to a second channel rigged with at least a second magnet and connected to a second output channel at the position of the second magnet.

24. The method of claim 16, further comprising collecting at least one of: separate pure rare earth compounds and separated groups of rare earth compounds.

25. The method of claim 16, further comprising separating remaining groups of rare earth compounds using one of: ferromagnetic trapping of RE particles and differential settling in water.

26. The method of claim 16, comprising selecting at least one paramagnetic solvent.

27. The method of claim 16, comprising selecting at least one solvent and tailoring its magnetic properties in relation to the rare earth compounds to be separated.

28. A method for separating individual rare earth element compounds from an ore, comprising:
a) liberating natural RE-bearing minerals from the ore;
b) separating and concentrating RE-rich material minerals from the RE-bearing minerals to yield RE mineral concentrates;
c) separating mixed RE compounds from the RE mineral concentrates;
d) passing a slurry of the mixed RE compounds in a first channel rigged with magnets arranged progressively from weakest to strongest along a length thereof, the channel being connected, at the position of each magnet, to an output channel, each output channel diverting at least one of: i) separated groups of rare earth element compounds and ii) separated rare earth element compounds, from the mixed RE compounds slurry;
e) in case of separated groups of rare earth element compounds, for at least one of the groups, continuing to one of: i) passing the group to a second channel rigged with magnets arranged progressively from weakest to strongest along a length thereof, the second channel being connected, at the position of each magnet, to an output channel and ii) separating the compounds of the group using a magnetic field; and
f) repeating said step e) until a target separation between the rare earth element compounds.

29. The method of claim 28, comprising prior to said step d), removing ferromagnetic RE compounds elements from the mixed rare earth element compounds using a magnetic field.

30. The method of claim 28, comprising, before said step d), removing diamagnetic RE compounds from the mixed rare earth element compounds using a magnetic field.

31. The method of claim 28, comprising selecting a supporting fluid for the slurry of the mixed RE compounds.

32. The method of claim 28, comprising selecting at least one paramagnetic solvent.

33. The method of claim 28, comprising selecting at least one solvent and tailoring its magnetic properties in relation to the rare earth compounds to be separated.
